(19) United States
(12) Patent Application Publication
(10) Pub. No.: US 2013/0332299 A1
(43) Pub. Date: Dec. 12, 2013

(54) APPLICATION PRICING METHOD AND APPARATUS

(71) Applicant: Huawei Technologies Co., Ltd., Shenzhen (CN)

(72) Inventors: Jie Zhang, Beijing (CN); Feng Liu, Shenzhen (CN); Peng Li, Beijing (CN)

(73) Assignee: Huawei Technologies Co., Ltd., Shenzhen (CN)

(21) Appl. No.: 13/969,086

(22) Filed: Aug. 16, 2013

Related U.S. Application Data
(63) Continuation of application No. PCT/CN2011/073158, filed on Apr. 22, 2011.

(51) Int. Cl. G06Q 30/06

(52) U.S. Cl. CPC G06Q 30/0605
USPC 705/26.2

(57) ABSTRACT

The present invention discloses an application pricing method and apparatus, pertaining to the field of the field of software technologies. The method includes: packaging a plurality of applications to obtain an application package; obtaining prices of applications in the application package in a predetermined charging mode; and obtaining by calculation the price of the application package in the predetermined charging mode according to the prices of the applications. According to the technical solutions of the present invention, an application package can be conveniently and quickly priced, and the charging mode of the application package is flexible and diversified.

### CROSS-REFERENCE TO RELATED APPLICATIONS

This application is a continuation of International Application No. PCT/CN2011/073158, filed on Apr. 22, 2011, which is hereby incorporated by reference in its entirety.

### TECHNICAL FIELD

The present invention relates to the field of software technologies, and in particular, to an application pricing method and apparatus.

### BACKGROUND

With popularity of data services, and especially the advent of the 3G era, applications preinstalled on a mobile terminal cannot meet a user's diversified data service demands. Therefore, the user starts downloading a large number of applications over the network.

An application store, as an application download platform, provides convenient and quick access for the user to download applications over the network. Specifically, a developer may upload and release developed applications to a page of the application store; and a user may browse, buy, and download a desired application on the page of the application store.

In the prior art, the application store only provides a service for the user to download one application once, and charges for the application once at a price specified by the developer before the application is downloaded.

As mentioned above, applications currently provided by the application store have a fixed and single charging mode; and in addition, when a user desires to download a plurality of applications, the application store must complete download of and charging for each application separately. As a result, similar download and charging operations are repeated multiple times, causing a resource waste.

### SUMMARY

Embodiments of the present invention provide an application pricing method and apparatus. The technical solutions are as follows:

An application pricing method includes:

packaging a plurality of applications to obtain an application package;

obtaining prices of applications in the application package in a predetermined charging mode; and obtaining by calculation the price of the application package in the predetermined charging mode according to the prices of the applications.

An application pricing apparatus includes: a packaging module, an obtaining module, and a pricing module, where:

the packaging module is configured to package a plurality of applications to obtain an application package;

the obtaining module is configured to obtain prices of applications in the application package in a predetermined charging mode; and

the pricing module is configured to obtain by calculation the price of the application package in the predetermined charging mode according to the prices of the applications.

According to the technical solutions provided in the present invention, an application package is conveniently and quickly priced, and the charging mode of the application package is flexible and diversified.

### BRIEF DESCRIPTION OF THE DRAWINGS

FIG. 1 is a flowchart of an application pricing method according to Embodiment 1 of the present invention;

FIG. 2 is a flowchart of an application pricing method according to Embodiment 2 of the present invention;

FIG. 3 is a block diagram of an application pricing apparatus according to Embodiment 3 of the present invention; and

FIG. 4 is a block diagram of an application pricing apparatus according to Embodiment 4 of the present invention.

### DETAILED DESCRIPTION

To make the objectives, technical solutions, and advantages of the present invention clearer, the embodiments of the present invention are hereinafter described in detail with reference to the accompanying drawings.

### Embodiment 1

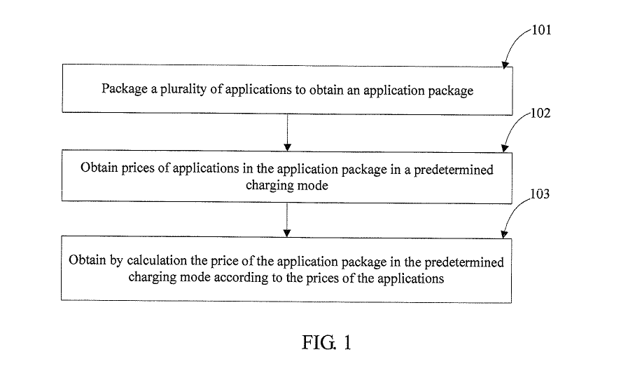

Referring to FIG. 1, an application pricing method is provided. The execution entity of the method includes but is not limited to an application store server. The method includes the following steps:

Step 101: Package a plurality of applications to obtain an application package.

Specifically, a plurality of applications specified by an application seller in advance are packaged, or a plurality of applications specified as desired by an application buyer are packaged.

Step 102: Obtain prices of applications in the application package in a predetermined charging mode, where the predetermined charging mode includes but is not limited to charging by the number of times before download, monthly charging, and charging by value-added service in an application.

Step 103: Obtain by calculation the price of the application package in the predetermined charging mode according to the prices of the applications.

According to the technical solution provided in the embodiment of the present invention, an application package can be conveniently and quickly priced, and the charging mode of the application package is flexible and diversified.

### Embodiment 2

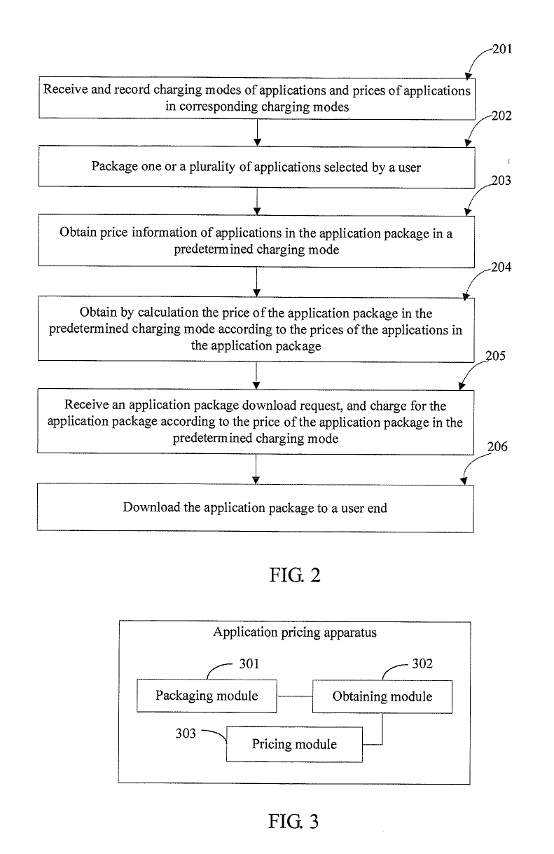

Referring to FIG. 2, an application pricing method is provided. The execution entity of the method includes but is not limited to an application store server. The method includes the following steps:

Step 201: Receive and record charging modes of applications and prices of applications in corresponding charging modes to obtain application price record information.

Specifically, a developer uploads an application to an application store server, and specifies a charging mode and corresponding price for the uploaded application; the application store server presents the application uploaded by the developer, the corresponding charging mode and the price in the corresponding charging mode on a foreground page; and the background records and manages the charging mode of the application uploaded by the developer and the price in the corresponding charging mode.

The charging mode of the application includes one or a plurality of: charging by the number of times before download, monthly charging, and charging by value-added service in an application.

For example, Table 1 shows the content of the application price record.

TABLE 1

| Developer | Application | Charging Mode | Price |
|---|---|---|---|
| Developer 1 | Application 1 | Monthly charging | Price 1 (for example, 10 |
| | | | yuan/month) |
| | | Charging by the number of | Price 2 (for example, 10 |
| | | times before | yuan/month) |
| | | download | |
| | | Charging by value-added | NULL |
| | | service in an | |
| | | application | |
| Developer 2 | Application 2 | Monthly charging | Price 3 (for example, 5 |
| | | | yuan/month) |
| | | Charging by the number | NULL |
| | | of times before | |
| | | download | |
| | | Charging by value-added | NULL |
| | | service in an | |
| | | application | |
| Developer 3 | Application 3 | Charging by value-added | Price 4 (for example, 10 |
| | | service in an | yuan/value-added service) |
| | | application | |
| | | Charging by the number | NULL |
| | | of times before | |
| | | download | |
| | | Charging by value-added | NULL |
| | | service in an | |
| | | application | |
| Developer 4 | Application 4 | Monthly charging | Price 5 (for example, 15 |
| | | | yuan/month) |
| | | Charging by the number | Price 6 (for example, 15 |
| | | of times before | yuan/month) |
| | | download | |
| | | Charging by value-added | Price 7 (for example, 3 |
| | | service in an | yuan/value-added |
| | | application | service) |
| | . . . | . . . | . . . |

It should be noted that the application store server may adjust the prices of the applications in their respective charging modes.

Specifically, while specifying a charging mode for an application, the developer submits a dynamic pricing algorithm of the application in the corresponding charging mode to the application store server. The dynamic pricing algorithm specifies a price adjustment policy of the application in the corresponding charging mode, where the adjustment policy includes adjusting a price according the history download times of the application, and adjusting the price according to the class of the application store server. The application store server adjusts a price of the application in different charging modes according to the adjustment policy specified by the developer, for example, setting different discounts based on an original price according to the history download times of the application, or setting different discounts based on the original price according to the class of the application store server.

For example, with the increase of download times of application 1, a discount is made off the price of application 1 in the monthly charging mode. When the number of download times of application 1 exceeds 100, a 2% discount is made off the price 1 of application 1 in the monthly charging mode; and when the number of download times of application 1 exceeds 1000, a 10% discount is made off the price 1 in the monthly charging mode.

For another example, if the class of the application store server is 5, a 5% discount is made off the price of an application in the application store server in the corresponding charging mode.

Step 202: Package one or a plurality of applications selected by a user.

Specifically, one or a plurality of applications specified by an application seller in advance are packaged, or one or a plurality of applications specified as desired by an application buyer are packaged.

As shown in Table 1, application 1 and application 4 specified as desired by an application buyer are packaged.

Step 203: Obtain price information of applications in the application package in a predetermined charging mode.

The predetermined charging mode includes but is not limited to charging by the number of times before download, monthly charging, and charging by value-added service in an application

Specifically, generating the price information of the application package includes:

Step 203-1: Obtain the prices of the applications in the application package in the predetermined charging mode by inquiring an application price record.

For example, if the predetermined charging mode is charging by value-added service in an application, as shown in Table 1, the application price record is inquired and it is learned that the price of application 1 is null and that the price of application 4 is 3 yuan/value-added service in the application package in the mode of charging by value-added service in an application.

Step 203-2: If the price of an application in the application package in the predetermined charging mode is null, set a price for the application with a null price in the predetermined charging mode according to a predetermined method.

For example, in the mode of charging by value-added service in an application, the price of application 1 in the application package is null.

Specifically, a price is set for an application with a null price in the predetermined charging mode by using the following two methods:

Method 1 (history statistic method: Obtain the price of an application with a null price in another charging mode by inquiring the application price record, and obtain by estimation the price of the application with a null price in the predetermined charging mode according to the price of the application with a null price in the another charging mode.

For example, when it is learned by inquiry that the price of application 1 in the application package is 10 yuan/month in the monthly charging mode, and is 10 yuan/times in the mode of charging by the number of times before download, if application 1 includes three value-added services, the price of application 1 in the policy of charging by value-added service in an application is set to 4 yuan/value-added service. In this way, in the mode of charging by value-added service in an application, the total price of application 1 is 12 yuan, which is close to, that is, a little higher than, the price in the monthly charging mode or the mode of charging by the number of times before download.

Method 2 (similarity comparison algorithm): Obtain prices of applications of the same type as the application with a null price in the predetermined charging mode by inquiring the application price record, and obtain by estimation the price of the application with a null price in the predetermined charging mode according to the prices of the applications of the same type as the application with a null price in the predetermined charging mode.

For example, if it is learned by inquiry that the prices of application 10, application 12, application 15, . . . , which are of the same application type as application 1 in the application package, are 3 yuan/value-added service, 3.5 yuan/value-added service, 4 yuan/value-added service, . . . , in the mode of charging by value-added service in an application, respectively, the price of application 1 in the mode of charging by value-added service in an application may be estimated to be 4 yuan/value-added service according to the above information. This is because applications of the same type have similar prices.

It should be noted that, to improve reasonability of the price of an application with a null price in the predetermined charging mode, based on method 1 or method 2, reference is made to statistical information related to the application with a null price during the setting of the price in the predetermined charging mode for the application with a null price.

It should be noted that the application store server monitors and records statistical information of each application in a store in real time, where the statistical information includes history record information such as download times, download traffic, and duration.

For example, Table 2 shows statistical information of an application with a null price in another charging mode.

TABLE 2

| | | | |
|---|---|---|---|
| | | Characteristic | |
| Times | Traffic | Quantity | Monthly Charging |

| | |
|---|---|
| Download | Collecting statistics of usage per user |
| Times | Collecting statistics of usage each time |
| Traffic | . . . |
| Duration | . . . |
| Monthly | . . . |
| Charging | |

When method 1 is used to set a price for the application with a null price in the predetermined charging mode, the information referred to also includes the statistical information.

For example, if it is learned by inquiry that the price of application 1 in the application package is 10 yuan/month in the monthly charging mode, and 10 yuan/times in the mode of charging by the number of times before download, and it is learned from the statistical information that application 1 is downloaded for three times within a month as value-added services, the price of application 1 in the policy of charging by value-added service in an application is estimated to be 3.3 yuan/value-added service according to the statistical information.

For example, Table 3 shows statistical information of an application of the same type as the application with a null price in the corresponding charging mode.

TABLE 3

| | | |
|---|---|---|
| Period with Maximum | Initial Period | Period with Stable |
| Download Times | After Release | Download Times |

| | |
|---|---|
| Download | Collecting statistics of usage per user |
| Times | Collecting statistics of usage each time |
| Traffic | . . . |
| Duration | . . . |
| Monthly | . . . |
| Charging | |

When method 2 is used to set a price for the application with a null price in the predetermined charging mode, the information referred to also includes the statistical information.

For example, if it is learned by inquiry that the prices of application 10, application 12, application 15, . . . , which are of the same application type as application 1 in the application package, are 3 yuan/value-added service, 3.5 yuan/value-added service, 4 yuan/value-added service, . . . , in the mode of charging by value-added service in an application, respectively, the price of application 1 in the mode of charging by value-added service in an application may be estimated to be 4 yuan/value-added service according to the above information.

Step 204: Obtain by calculation the price of the application package in the predetermined charging mode according to the prices of the applications in the application package.

Specifically, the price of the application package in the predetermined charging mode is obtained by calculation according to the prices of the applications in the application package in the following two methods:

Method 1: Add the prices of the applications to obtain the price of the application package in the predetermined charging mode.

In specific implementation, the price of the application package in the predetermined charging mode may be obtained by using the formula p^{j}=Σwᵢ^{j}cᵢ^{j}.

p^{j} indicates the price of application package p in predetermined charging mode j.

wᵢ^{j}Cᵢ^{j} indicates the price of application i in the application package in predetermined charging mode j. Cᵢ^{j} indicates the original price of application i in the application package in predetermined charging mode j, wᵢ^{j} indicates a price adjustment percentage of application i in the application package in predetermined charging mode j, where the value of wᵢ^{j} varies from 1 to 0, and when the value of wᵢ^{j} is 1, the price of application i in the application package is not adjusted.

Method 2: Add the prices of the applications and then add a cost to obtain the price of the application package in the predetermined charging mode, where the cost is the profit of a seller.

In specific implementation, the price of the application package in the predetermined charging mode may be calculated by using the calculation formula pⱼ=c₀^{j}+Σwᵢ^{j}cᵢ^{j}, where C₀^{j} indicates the profit of the seller in determining charging mode j.

It should be noted that p^{j} is set in consideration of the profit of an application seller in the case that an application developer and an application seller are not the same.

The prices of the application package in the predetermined charging modes being charging mode 1, charging mode 2, . . . , and charging mode j may be obtained by repeatedly performing steps 203 and 204. Table 4 shows price information of the application package in various charging modes in consideration of the profit of the seller.

TABLE 4

| | | Appli- | | Appli- | | | Appli- | | Application |
|---|---|---|---|---|---|---|---|---|---|
| | Cost | cation 1 | | cation 2 | | . . . | cation i | | Package Price |
| Charging | c₀¹ | w₁¹ | c₁¹ | w₂¹ | c₂¹ | . . . | wᵢ¹ | cᵢ¹ | p¹ = c₀¹ + |
| Mode 1 | | | | | | | | | Σ wᵢ¹cᵢ¹ |
| Charging | c₀² | w₁² | c₁² | w₂² | c₂² | . . . | wᵢ² | cᵢ² | p² = c₀² + |
| Mode 2 | | | | | | | | | Σ wᵢ²cᵢ² |
| Charging | c₀³ | w₁³ | c₁³ | w₂³ | c₂³ | . . . | wᵢ³ | cᵢ³ | p³ = c₀³ + |
| Mode 3 | | | | | | | | | Σ wᵢ³cᵢ³ |
| . . . | . . . | . . . | . . . | . . . | . . . | . . . | . . . | . . . | . . . |
| Charging | c₀^{j} | w₁^{j} | c₁^{j} | w₂^{j} | c₂^{j} | . . . | wᵢ^{j} | cᵢ^{j} | p^{j} = c₀^{j} + |
| Mode j | | | | | | | | | Σwᵢ^{j}cᵢ^{j} |

Step 205: Receive an application package download request, and charge for the application package according to the price of the application package in the predetermined charging mode.

Step 206: Download the application package to a user end.

According to the technical solution provided in the embodiment of the present invention, an application store server is capable of pricing an application package quickly and conveniently, and the charging mode of the application package is flexible and diversified. In addition, by packaging a plurality of applications, a user can buy a plurality of applications in a one-stop manner. This reduces the time for selecting applications.

### Embodiment 3

Referring to FIG. 3, an application pricing apparatus is provided. The apparatus is specifically the same as the execution entity in Embodiment 2, including: a packaging module 301, an obtaining module 302, and a pricing module 303.

The packaging module 301 is configured to package a plurality of applications to obtain an application package.

The obtaining module 302 is configured to obtain, in a predetermined charging mode, prices of applications in the application package obtained by the packaging module 301.

The pricing module 303 is configured to obtain by calculation the price of the application package in the predetermined charging mode according to the prices of the applications obtained by the obtaining module 302.

According to the technical solution provided in the embodiment of the present invention, an application store server is capable of pricing an application package quickly and conveniently, and the charging mode of the application package is flexible and diversified. In addition, by packaging a plurality of applications, a user can buy a plurality of applications in a one-stop manner. This reduces the time for selecting applications.

### Embodiment 4

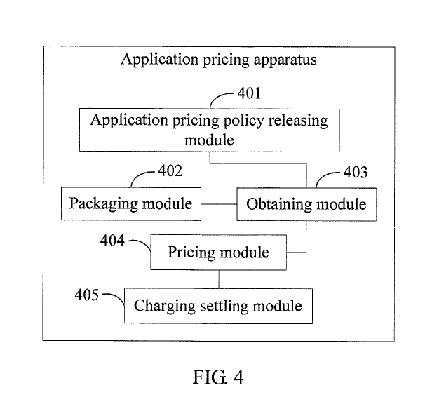

Referring to FIG. 4, an application pricing apparatus is provided. The apparatus may be specifically the same as the execution entity in Embodiment 2, including: an application pricing policy releasing module 401, a packaging module 402, an obtaining module 403, a pricing module 404, and a charging settling module 405.

The application pricing policy releasing module 401 is configured to receive and record charging modes of applications and prices of applications in corresponding charging modes to obtain an application price record.

The packaging module 402 is configured to package a plurality of applications to obtain an application package.

Specifically, the packaging module 402 is configured to package a plurality of applications that are specified by an application seller in advance; or

the packaging module 402 is configured to package a plurality of applications specified as desired by an application buyer.

The obtaining module 403 is configured to obtain, from the application pricing policy releasing module 401, prices of applications in the application package obtained by the packaging module 402 in a predetermined charging mode.

Specifically, the obtaining module 403 includes: an obtaining unit 4031, configured to obtain, by inquiring the application price record obtained by the application pricing policy releasing module 401, the prices of the applications in the application package obtained by the packaging module 402 in the predetermined charging mode; and

a pricing unit 4032, configured to set, if the price of an application in the application package in the predetermined charging mode is null, a price for the application with a null price in the predetermined charging mode according to a predetermined method.

The pricing unit 4032 is specifically configured to obtain the price of the application with a null price in another charging mode by inquiring the application price record, and obtain by estimation the price of the application with a null price in the predetermined charging mode according to the price of the application with a null price in the another charging mode; or

the pricing unit 4032 is specifically configured to obtain prices of applications of the same type as the application with a null price in the predetermined charging mode by inquiring the application price record, and obtain by estimation the price of the application with a null price in the predetermined charging mode according to the prices of the applications of the same type as the application with a null price in the predetermined charging mode.

The pricing module 404 is configured to obtain by calculation the price of the application package in the predetermined charging mode according to the prices of the applications obtained by the obtaining module 403.

Specifically, the pricing module 404 is configured to add the prices of the applications obtained by the obtaining module 403 to obtain the price of the application package in the predetermined charging mode; or

the pricing module 404 is specifically configured to add the prices of the applications obtained by the obtaining module 403 and then add a cost to obtain the price of the application package in the predetermined charging mode, where the cost is the profit of a seller.

The charging settling module 405 is configured to charge, when the application package is downloaded, for download of the application package according to the price obtained by the pricing module 404.

The apparatus further includes an adjusting module 406, configured to adjust the prices of the applications in the application package in the predetermined charging mode according to a dynamic pricing algorithm uploaded by a developer.

According to the technical solution provided in the embodiment of the present invention, an application store server is capable of pricing an application package quickly and conveniently, and the charging mode of the application package is flexible and diversified. In addition, by packaging a plurality of applications, a user can buy a plurality of applications in a one-stop manner. This reduces the time for selecting applications.

All or part of the content in the technical solutions provided in the foregoing embodiments may be implemented by software programs, and the software programs are stored in readable storage media such as a hard disk, an optical disk, or a floppy disk in a computer.

The foregoing description is merely about the exemplary embodiments of the present invention, and is not intended to limit the present invention. Any modification, equivalent replacement, or improvement made within the idea and principle of the present invention shall all fall within the protection scope of the present invention.

What is claimed is:

1. An application pricing method, comprising:
packaging a plurality of applications to obtain an application package;
obtaining prices of applications in the application package in a predetermined charging mode; and
obtaining by calculation a price of the application package in the predetermined charging mode according to the prices of the applications.

2. The method according to claim 1, wherein obtaining prices of applications in the application package in a predetermined charging mode comprises:
obtaining the prices of the applications in the application package in the predetermined charging mode by inquiring an application price record; and
if a price of an application in the application package in the predetermined charging mode is null, setting a price for the application with a null price in the predetermined charging mode according to a predetermined method.

3. The method according to claim 2, wherein setting a price for the application with a null price in the predetermined charging mode according to a predetermined method comprises:
obtaining a price of the application with a null price in another charging mode by inquiring the application price record, and obtaining by estimation the price of the application with a null price in the predetermined charging mode according to the price of the application with a null price in the another charging mode; or
obtaining prices of applications of the same type as the application with a null price in the predetermined charging mode by inquiring the application price record, and obtaining by estimation the price of the application with a null price in the predetermined charging mode according to the prices of the applications of the same type as the application with a null price in the predetermined charging mode.

4. The method according to claim 1, wherein obtaining by calculation a price of the application package in the predetermined charging mode according to the prices of the applications comprises:
adding the prices of the applications to obtain the price of the application package in the predetermined charging mode.

5. The method according to claim 1, wherein obtaining by calculation a price of the application package in the predetermined charging mode according to the prices of the applications comprises:
adding the prices of the applications and then adding profits of a seller to obtain the price of the application package in the predetermined charging mode.

6. The method according to claim 1, further comprising: adjusting the prices of the applications in the application package in the predetermined charging mode according to a dynamic pricing algorithm uploaded by a developer.

7. An application pricing apparatus, comprising a packaging module, an obtaining module, and a pricing module, wherein:
the packaging module is configured to package a plurality of applications to obtain an application package;
the obtaining module is configured to obtain prices of applications in the application package in a predetermined charging mode; and
the pricing module is configured to obtain by calculation a price of the application package in the predetermined charging mode according to the prices of the applications.

8. The apparatus according to claim 7, wherein the obtaining module comprises:
an obtaining unit, configured to obtain the prices of the applications in the application package in the predetermined charging mode by inquiring an application price record; and
a pricing unit, configured to set, if a price of an application in the application package in the predetermined charging mode is null, a price for the application with a null price in the predetermined charging mode according to a predetermined method.

9. The apparatus according to claim 8, wherein the pricing unit is configured to obtain a price of the application with a null price in another charging mode by inquiring the application price record, and obtain by estimation the price of the application with a null price in the predetermined charging mode according to the price of the application with a null price in the another charging mode; or
the pricing unit is configured to obtain prices of applications of the same type as the application with a null price in the predetermined charging mode by inquiring the application price record, and obtain by estimation the price of the application with a null price in the predetermined charging mode according to the prices of the applications of the same type as the application with a null price in the predetermined charging mode.

10. The apparatus according to claim 7, wherein the pricing module is configured to add the prices of the applications to obtain the price of the application package in the predetermined charging mode.

11. The apparatus according to claim 7, wherein the pricing module is configured to add the prices of the applications and then add profits of a seller to obtain the price of the application package in the predetermined charging mode.

12. The apparatus according to claim 7, further comprising: an adjusting module, configured to adjust the prices of the applications in the application package in the predetermined charging mode according to a dynamic pricing algorithm uploaded by a developer.
